(19) United States
(12) Patent Application Publication
(10) Pub. No.: US 2003/0010108 A1
(43) Pub. Date: Jan. 16, 2003

(54) Method and system for measuring vehicle tire deformation and a tire having such a system

(75) Inventors: Marius Goslar, Braunschweig (DE); Klaus Kleinhoff, Rodenberg (DE)

Correspondence Address: ROBERT W. BECKER & ASSOCIATES, Suite B, 707 Highway 66 East, Tijeras, NM, 87059, US

(73) Assignee: Continental Aktiengessellschaft, Hannover (DE)

(21) Appl. No.: 10/193,453

(22) Filed: Jul. 10, 2002

(30) Foreign Application Priority Data
Jul. 10, 2001 (DE) 101 33 428.1

(51) Int. Cl. G01M 17/02

(52) U.S. Cl. 73/146; 152/525; 152/152.1

(57) ABSTRACT

A vehicle tire comprising a tread and a pair of sidewalls has a radially inner track and a radially outer track on a sidewall, each track being formed of a plurality of magnetically active sectors arranged in an angular serial manner to one another. Each sector is delimited from the next following sector by a respective sector transition and has a different magnetic property than the next following sector. A first group of the sector transitions have a radial extent forming a first angle relative to a radius of the tire and a second group of the sector transitions have a radial extent forming a second angle relative to a radius of the tire which is different than the first sector transition angle. Conclusions concerning the tangential tire deformation can be drawn from signals generated by magnetically sensing the phase shift of the magnetically active track sectors.

### BACKGROUND OF THE INVENTION

The present invention relates to a system and method for measuring the deformations of vehicle tires.

The present invention relates to a vehicle tire having at least one sidewall magnetically active in at least one portion thereof, the one portion comprising at least one inner and one outer concentric magnetically active track, whereby the tracks each comprise a plurality of sectors which are magnetically differently active from one another.

The invention further relates to a system for measuring the deformation or deflection of vehicle tires, whereby a respective magnetic sensor is oriented toward one of at least two concentric tracks of magnetized sectors and an evaluation unit is connected with the magnetic field sensors, whereby the evaluation unit is configured for evaluating the tangential deflection or deformation of the vehicle tire by evaluation of the phase angles between the measured signals for the tracks disposed at different radii from one another.

The present invention further relates to a method for measuring the deformation or deflection of vehicle tires by means of respective magnetic field sensors each oriented toward a respective one of at least two concentric tracks of magnetized sectors, whereby the tangential deformation or deflection of the vehicle tire is evaluated from the phase angles between the measured signals for the tracks disposed at differing radii from one another.

To effect the measurement of the tangential deformation of vehicle tires, especially deformations which occur in connection with the braking of a vehicle in which the brake force acts eccentrically on the tire and thereby produces the torsional torque moments, an arrangement is disclosed in DE-OS 44 35 160 A1 in which a vehicle tire has concentric magnetized tracks with different radii, the tracks being disposed in the sidewall of the vehicle tire. The tracks are comprised of a plurality of magnetized sectors arranged in neighboring relation to one another with alternating magnetic pole directions as are produced, preferably, by an apparatus as disclosed in DE-PS 196 46 251 C2. The sectors are configured and oriented such that the transitions between the sectors extend radially to the vehicle tire—that is, radially through the axis of rotation of the tire.

Magnetic field sensors are mounted in a non-rotating manner in the neighborhood of these tracks, each of the magnetic field sensors being operable to sense magnetic activity with the sensed signals defining a specific curve of the magnetic field strength over time during each rotation of the vehicle tire and thereby provide a measurement of the rotational angle for the respective one of the concentric tracks evaluated by the magnetic field sensor. These curves are hereinafter referred to as “magnetic field curves.”

The phase differences, which occur between the magnetic field curves of the tracks of differing radii during tangential deformation of the vehicle tire, are a measure of the tangential deformation and, thereby, of the longitudinal force of interest. The lateral force can, furthermore, be determined by the amplitude of the magnetic field curve.

In one configuration of a known solution, the magnetic field sensors are arranged vertically or perpendicularly relative to the road surface over which the vehicle tire travels and above the middle point or axis of rotation of the vehicle tire. The sensors are disposed at an angle of approximately 180 degrees from one another relative to the radius between the axis of rotation of the tire and the middle of the tire contact surface. In this so-called 180-degree disposition, the tangential deformations of the vehicle tire can be detected independent of the tire suspension or damping. In order to gain information as well about the tire suspension, in accordance with this state of the art arrangement, the implementation of a second pair of sensors is required, preferably in 90-degree or 270-degree dispositions. The tire suspension is dependent principally or substantially upon the wheel load and the air pressure or, respectively, the relationship between the wheel load and the air pressure. One can draw conclusions concerning the tire suspension by evaluation of the relationship of the wheel load to the tire pressure or, if one of these two measures is known, one can draw conclusions about the other of these measures.

### SUMMARY OF THE INVENTION

The present invention provides a solution to the challenge of providing an improved vehicle tire and a system and a method for measuring the deformation or deflection of the vehicle tire such that the tire suspension can be measured. In connection with the present invention, a single pair of sensors should be sufficient in order to limit the risk of an operational fall-out and the cost to a low level. In this connection, an expression or display of the wheel load or the air pressure (the air overpressure in the tire) based upon the tangential deformation measurement is possible with only a single pair of sensors; it follows therefrom that one can derive as well an expression concerning the air pressure or, respectively, the wheel load, if the knowledge of the relationship of the wheel load to the air pressure is not already sufficient to derive this information. The latter measurement —that is, the wheel load—is the easier of the two to measure via, for example, an elongation measurement strip in the event that the configuration includes a steel spring or a pressure measurement jet in a configuration comprising an air suspension.

The vehicle tire in accordance with the present invention provides a solution to this challenge and is characterized in that, of the individual sector transitions between magnetized sectors, some of the sector transitions extend in a first inclination relative to the radius of the vehicle tire while other sector transitions between magnetized sectors extend in a different, second inclination relative to the radius of the vehicle tire.

The vehicle tire is configured such that the more the tire is flattened, the higher the wheel load thereon and, therefore, the lower the overpressure in the tire interior. The middle point of the stiff rim approaches, therefore, the road contact surface. The path followed by the rim in approaching the road contact surface is also characterized as the tire suspension.

The tire suspension has, in the 0 (zero)-degree and in the 180 degree sensor dispositions, no influence on the passage time point (time to complete a rotation) of the respective sector transitions which extend radially to the rotational axis of the vehicle tire.

On the other hand, the angle α changes which extends at an offset to the radius of the sectors in connection with the differing tire suspension configurations. Accordingly, the passage time points change as well and, thereby, the time intervals which are to be measured and these measurements increase in correspondence with the increasing offset inclination of the sector borders relative to the radius of the vehicle tire. The phase differences which are detected by the magnetic field sensors during passage of the diagonal sector borders are, thus, corresponding signals of the tangential deformation of the vehicle tire which are dependent on, or vary as a function of, the tire suspension or damping.

The phase changes which are detected by the magnetic field sensors during passage of the typical (i.e. radially extending) sector borders deliver, in contrast, a signal representative of the tangential deformation of the vehicle tire which is independent of the vehicle suspension. The independent signal, which is independent of the given dimensioning, is particularly easy to interpret and permits a separation of the two individual pieces of information even if the difference in the degree of dependency of the two signals is only adequate. For example, one sector border can be disposed at approximately 2° and the other measured sector border can be disposed at approximately 80 inclination.

It is particularly advantageous if, in one or both magnetic tracks, the radial sector transitions and the sector transitions offset to a tire radius are arranged in alternating relationship to one another because the best possible evaluation of the tire turning angle for both measured dimensions can then be achieved. The alternating arrangement of the differently inclined sector borders produces alternating stronger and weaker measurements dependent upon respective stronger or weaker tire suspension configurations. Thus, the initial singular signal output can easily be divided into two signal outputs each of one half of the signal density (the signal frequency per rotational or full rotational angle).

Via evaluation of both thus-separated signal outputs or measurement results—that is, the two different tangential deformations—the tire suspension can additionally be evaluated as well as the transferred or carried over longitudinal force by means of only a single pair of sensors arranged in the 0 (zero)-degree or 180-degree dispositions relative to one another. These sensor dispositions have heretofore only permitted the measurement of the longitudinal force.

In addition to providing the advantage of cost savings, the ability to function with only a single pair of sensors in lieu of two pairs of sensors provides the advantage that it is, in fact, the sensor disposition at 180° from one another of a singular sensor pair which is most favorable, because this arrangement provides the least difficulties. Sensors in the 90 or 270° dispositions, in contrast, are disposed, in particular with a steerable axis, at substantial spacings from the tire rotating or tire braking components so that such components cannot be used as mounts for the sensors. Thus, the sensors in these dispositions must be provided with separate components to function as the signal or sensor mounts which brings therewith additional costs and which add to the vehicle's non-damped mass.

A further advantage distinguishes the inclined sector transitions in that three different inclinations can be used. To explain this advantage, initially, the following definitions are provided: The first radial inclination, which may be at zero degrees, is designated as “a”, the second is designated as “b”, and the third is designated as “c”. A sector transition (or, as well, a “sector border”) having the inclination “a” is designated as “5a”, a sector transition having the inclination “b” is designated as “5b”,and a sector transition having the inclination “c” is designated as “5c”.

With the results of the sector transitions such as, for example, 5a, 5b, 5c; 5a, 5b, 5c; 5a, 5b, 5c; and so forth, the already designated data such as the transferred longitudinal force and the tire suspension relative to the direction of rotation can be additionally evaluated.

In this connection, the inclination results—as set forth in the preferred configuration example described hereinabove —are asymmetric. This expression “asymmetric” means that the results gathered in the forward direction cannot be diminished by the results gathered in the reverse direction due to any given phase shift. Hereinafter, two further asymmetrical results are given: 5a, 5b, 5c, 5c, 5a, 5b, 5c, 5c, 5a, 5b, 5c, 5c; . . . 5a, 5b, 5c, 5b, 5c; 5a, 5b, 5c, 5b, 5c; 5a, 5b, 5c, 5b, 5c; . . . In contrast, this advantage is not obtainable by means of a symmetrical data set such as something along the lines of 5a, 5b, 5c, 5b; 5a, 5b, 5c, 5b; 5a, 5b, 5c, 5b . . .

As all of the above examples show, to simplify data interpretation by data interpretation software, all of the inclination results can be configured to be periodic. In this manner, it is especially advantageous to choose the smallest possible period length—that is, the absolute shortest amount 3, such as selected in the first example.

An aperiodic inclination data set would have the advantage that conclusions concerning the tire identification can be undertaken therefrom such as, for example, the speed-index arrangement with respect to a selected inclination data set. An appropriate software must thereafter be provided, preferably, a learning-capable or self-teaching capable software.

A recognition of the direction of rotation of the tire, as is possible through the known use of the three different inclinations of the sector transition, provides, for example, a monitoring of whether the tire, which has a profile which is specific to a selected direction of rotation, has been properly mounted. Moreover, in connection with a reverse movement of the tire, the functional integrity during driving and braking can be improved and, at the same time, the functional integrity of the ESP (electronic stability program) system can be improved.

In a system for measuring the deformation of a tire in accordance with the present invention, the functional manner of the invention is most easily described in connection with a particular operational scenario in which one of the two inclinations of the sector borders is set to equal zero, whereupon the evaluation unit produces:

a) a deformation signal independent of the tire suspension of the phase angles of the radial sector transitions, and

b) a deformation signal, which varies in dependence upon, or as a function of, the tire suspension, of the phase angles of the sector borders which extend at an offset to the radius of the tire.

Generally, in order to ensure that there is no shear of sector borders set at the inclination angle zero, the evaluation unit produces:

c) a deformation signal, which varies in dependence upon the tire suspension, of the phase angles of the sector transitions which are relatively less inclined relative to the radius of the tire, and

d) a deformation signal of stronger magnitude with respect to the tire suspension of the phase angles of the sector transitions which are more strongly inclined relative to—that is, form a greater angle with—the radius of theater.

Additionally, a similarly large inclination disposition of the various sector borders is possible, however in differing orientations; in this event, it is only necessary that there are differing incline sector borders.

Preferably by means of algorithms of the type known to one of skill in the art for solving linear equilibrium systems, both of these signals can be further handled so that a first signal independent of the tire suspension and a second signal which varies in dependence upon the tire suspension can be provided. Following a splitting of these two individual signals, it can be useful to dispose the signals in a data bus as the data has already been sufficiently handled and transformed in order to provide a total vehicle monitoring evaluation, be it for the purpose of calculation of an optimum brake engagement, a drive torque moment control, a steering engagement, or a warning concerning a minimum air pressure or the like.

The magnetic field sensors are preferably disposed vertically in a position with respect to the road surface and above the axis of rotation of the vehicle tire. The magnetic field sensors thus would be disposed relative to the radius of the vehicle tire in an angle of approximately 180°. In this disposition of the magnetic field sensors, tangential deformations of the vehicle tire can be evaluated independently of the vehicle suspension in that the sector transitions of the magnetized sectors extend radially to the axis of rotation of the vehicle tire.

The evaluation unit is configured to evaluate the tangential deformation independently of the tire suspension. By simple subtraction of the two values for the tangential deformation, which have been measured on the basis of the radial sector transitions and the offset sector transitions, a conclusion concerning the tire suspension and, thus, the wheel load and/or the air pressure can be drawn, especially if the relationship between the wheel load and the air pressure is known.

In accordance with the method of the present invention for measuring the deformation of the above-described vehicle tires, the portion of the tangential deformation of the tire which occurs independently of the tire suspension is derived from the phase angles of the radial sector transitions. Furthermore, the portions of the tangential deformation which vary in dependence upon the tire suspension are derived from the phase angles of the offset sector transitions.

The invention is described hereinafter in connection with the figures of the drawings.

### BRIEF DESCRIPTION OF THE DRAWINGS

FIG. 1 is a schematic view of a sidewall of an unloaded vehicle tire having concentric inner and outer tracks as well as magnetic field sensors, which, in the event of a loading of the vehicle tire, permit a determination of the lateral force transferred to the vehicle tire;

FIG. 1a is a graphical representation of the signals of the two sensors shown in FIG. 1 with, however, the phase shift between the two signals being shown in an exaggerated manner in order to more clearly illustrate this phase shift;

FIG. 2 is a schematic side view of the sidewall of a tire identical to that shown in FIG. 1 with, however, the tire being deformed (the deformation being shown in an exaggerated manner);

FIG. 3 is a graphic representation of the sidewall deformation ΔU in connection with a loading of the vehicle tire solely by a wheel load (shown in broken lines) and a loading of the vehicle tire by both a wheel load and a braking force (shown as a solid line) in dependence upon the angular disposition β of the sensors;

FIG. 4 is a sectional view of the sidewall of a vehicle tire in accordance with the present invention whose transitions between the magnetic sectors extend radially in alternating manner between a radial inclination—that is, extending through the axis of rotation of the vehicle tire—and an inclination diagonal to a radius of the vehicle tire, whereby magnetic sectors extend between the outer and inner tracks without any phase offset, in contrast to those tracks shown in FIGS. 1 and 2;

FIG. 5 is a full view of the sidewall of the vehicle tire shown in FIG. 4, whereby, to avoid a graphic overloading, only the inclination angle α of one of the 16 sectors is displayed; and

FIG. 6 is a view similar to FIG. 5 of the sidewall of another vehicle tire in accordance with the present invention whose transitions between the magnetic sectors are arranged at three different inclinations (angles relative to the vehicle tire radius), whereby no phase offset is present between the outer and inner tracks of magnetized sectors.

### DETAILED DESCRIPTION OF THE PREFERRED EMBODIMENT

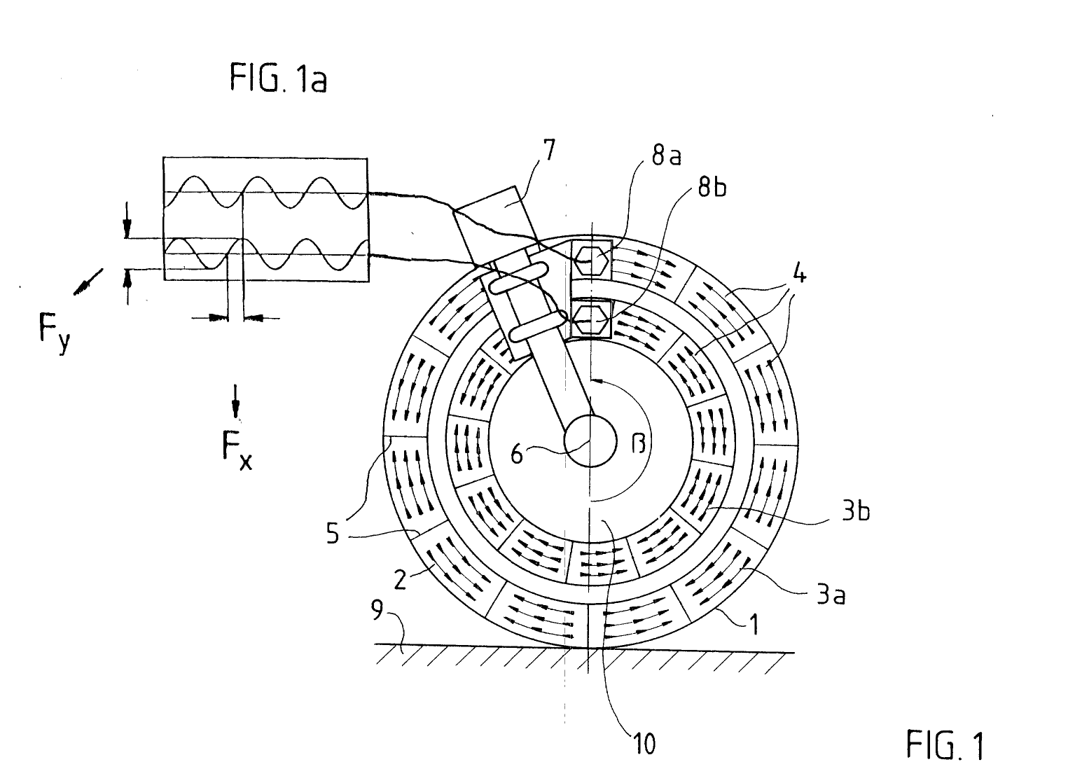

FIG. 1 schematically shows a typical arrangement for evaluating the tangential deformation of a vehicle tire 1. In the sidewall 2 of the tire 1, two concentric tracks 3a and 3b are provided having magnetized sectors 4 arranged serially with one another. The magnetic properties vary in a given manner from one sector 4 to another sector 4—that is, the magnetic field strength and/or the direction of the magnetic field lines and/or their orientations change; preferably, all of the sectors 4 have a field strength of the same value that is, the maximum possible value—and, in all sectors 4, in their respective middles, there is an orientation of the magnetic field lines along the circumferential direction, whereby the magnetic pole alternates from sector to sector—that is, in the middle of a respective sector, the magnetic pole has a given direction of rotation, in the middle of the next following sector, the magnetic pole has a direction of rotation in an opposite direction, in the middle of the thereafter following sector, the magnetic pole has yet again an opposite direction, and so forth. In the following description, it is assumed that, in fact, this conventionally known arrangement is implemented as the best configuration.

In the configuration shown in FIG. 1, a border extends between a respective adjacent pair of sectors 4, these borders being designated as sector borders 5 or sector transitions 5 being, typically, radially-oriented—that is, extending through the axis of rotation 6 of the vehicle tire 1.

Magnetic field sensors 8a, 8b are mounted on the suspension appendage 7, each magnetic field sensor being oriented for sensing the magnetic sector 4 of a respective one of the pair of tracks 3a, 3b.

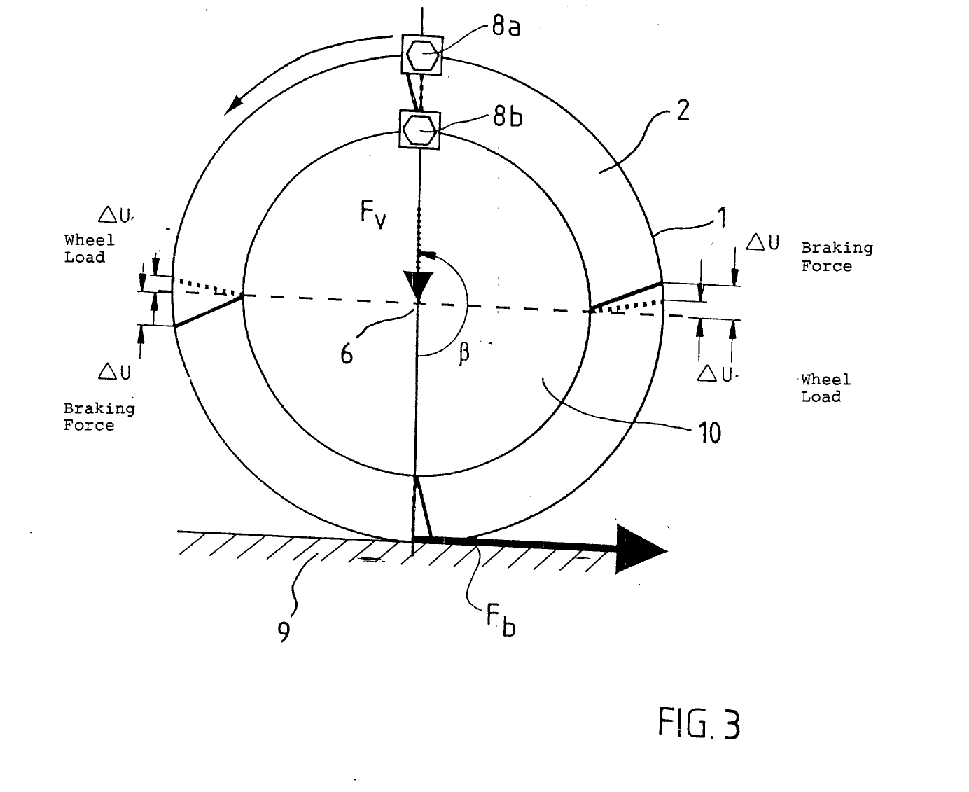

The significance of the signals generated from the magnetic field sensors is dependent upon the position of these magnetic field sensors relative to the middle of the tire contact surface. In this regard, the “position” is designated by the angle β between the respective pair of radial extents of which one extends from the rotational axis to the tire contact surface middle and the other extends through the middle between the two magnetic field sensors, as this is illustrated, in any event, in FIG. 3.

With reference again to FIG. 1: As can be seen therein, the magnetic field sensors 8a, 8b are preferably disposed in a 180° position. Due to the multiplicity of the alternating magnetized sectors 4 bordering one another and the alternating oriented magnetic poles correspondingly associated therewith, the curves as shown in FIG. 1a (viewable in the upper left of FIG. 1) derived from the magnetic sensing of the magnetic field sensors 8a, 8b have the periodic plots as shown.

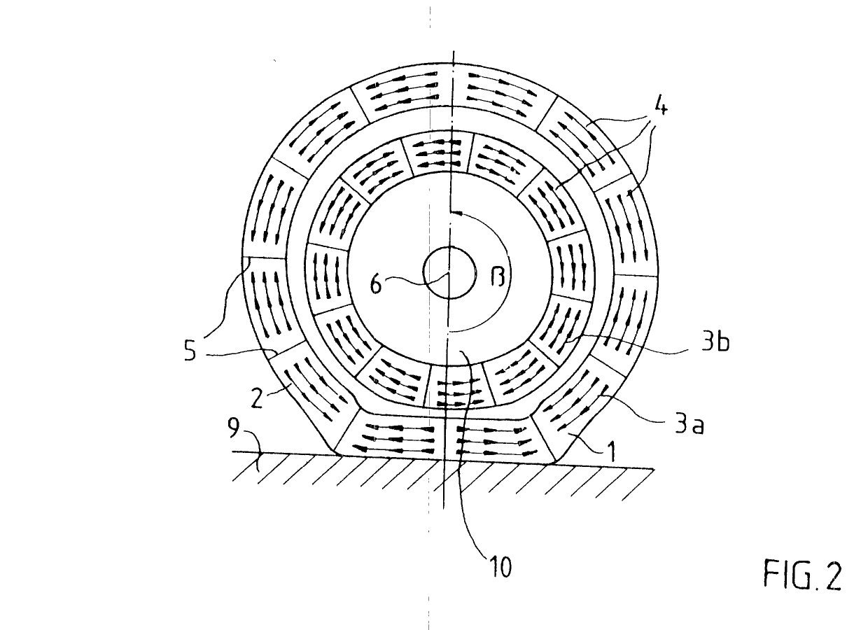

FIG. 2 shows, in connection with a tangential deformation of the vehicle tire 1—as occurs, for example, during braking of the vehicle—that, in the radially outer track 3a (the track at the greater radius), the magnetized sectors thereof shift through a larger phase angle (“phase angle” is the angle relative to a radius through the axis of rotation 6) than those magnetized sectors of the radially inner track 3b. The radially inner track 3b, as a result of its relatively smaller distance from the rim 10 and, additionally, as a result of the substantial material dimensioning forces exerted in the bead area, is more firmly interconnected to the rim 10 than the radially outward track 3a. The magnetic field results measured by the pair of magnetic field sensors 8a, 8b are thus displaced or offset from one another.

With knowledge of the rate of rotation, one can determine a displacement or offset angle from the phase difference between these magnetic field results. This displacement or offset angle between the measured magnetic field curves is a measure of the longitudinal force (e.g., force in the direction of tire travel), which is transferred to the vehicle tire.

In this context, it is noted that the amplitude of the fluctuations of the measured magnetic fields can be evaluated as well to provide a measure of the lateral force on the vehicle tire 1. This information is available because of the fact that the amplitude of the sensor signal rises in a strongly monotone manner as a function of the reduction in distance between the sensor and the vehicle tire (air gap), as is the case when a corresponding transverse force has influence on the tire.

FIG. 2 shows the sidewall 2 only of the vehicle tire 1 shown in FIG. 1. It can be clearly seen that all of the sector transitions 5 between the sectors 4 collectively extend through the middle point or axis of rotation 6 of the tire 1. This orientation is referred to herein as “radial.” A “radius” is, correspondingly, a straight line extending through the axis of rotation 6. The tire axis of rotation 6 is coincident with the midpoint of the wheel or rim 10.

If the tire is loaded—that is, deformed differently than it is in the condition in which it is shown in the heretofore described figures—and, thereby, is deformed especially in the tread surface area such that the tire is no longer perfectly round, the above-noted concepts are nonetheless still to be given their same meaning as they have been with respect to the unloaded tire.

With respect to the measurement of the tangential displacement or offset with the magnetic field sensors 8a, 8b in the so-called 180° position, the tire suspension assembly has no influence on the measured phase angle and the sensed tangential deformation.

The interdependence or interconnection of the tangential deformation upon the application of a braking force is shown in a schematic manner in FIG. 3. This schematic side view permits one to recognize the sidewall 2 of a tire 1 being rotated in a counterclockwise direction during the application thereto of a braking force F_{B} which causes tangential deformation of the tire. Due to the contour matching fitment of the tire 1 with the rim 10, the deformation is, at the innermost circumference of the tire, at its smallest and, at the outermost circumference of the tire 1, at its greatest and the reformulation substantially approaches the illustrated linear plot along the radius of the tire.

Upon the application of a braking force F_{B}, the tangential deformation is dependent upon the angle position β of the sensors with respect to the radius through the axis of rotation 6 of the vehicle tire 1 to the driving surface 9. As can be seen in the diagram, in connection with an angle β of 180°, the tangential deformation of a freely-rotating vehicle tire 1 equals zero. In contrast, upon the application, for example, of a braking force FB of 200 Newton meters (Nm), a tangential deformation of two millimeters (mm) is measured. Ideally, the magnetic field sensors 8a, 8b are disposed in the 180° position for effecting a measurement of the longitudinal force.

In order to permit a conclusion to be drawn concerning the relationship of the wheel loading of the tires to the overpressure in the interior of the tire, it has, before the present invention, been necessary to gather additional force information. This has brought with it, however, the disadvantage that additional sensors were required.

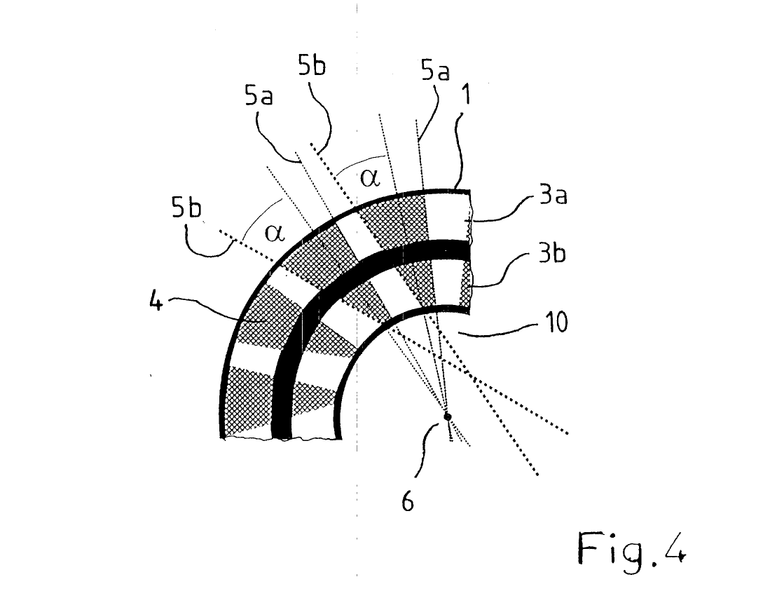

FIG. 4 is a sectional view of the sidewall 2 of a vehicle tire 1, in which, in accordance with the present invention, the sector transitions 5 between the magnetic field sectors 3a, 3b, are in alternating dispositions whereby a respective sector transition extends radially with an angle a equal to zero and the respective adjacent sector transition extends at an offset with respect to the radius passing through the axis of rotation of the vehicle tire at an angle of α not equal to zero. The first sector transitions 5a between the magnetized sectors 4 extend, therefore, radially through the axis of rotation of the vehicle tire. In contrast, the second sector transitions 5b extend between the magnetized sectors each at a respective angle α not equal to zero offset with respect to the radius through the axis of rotation of the vehicle tire 1.

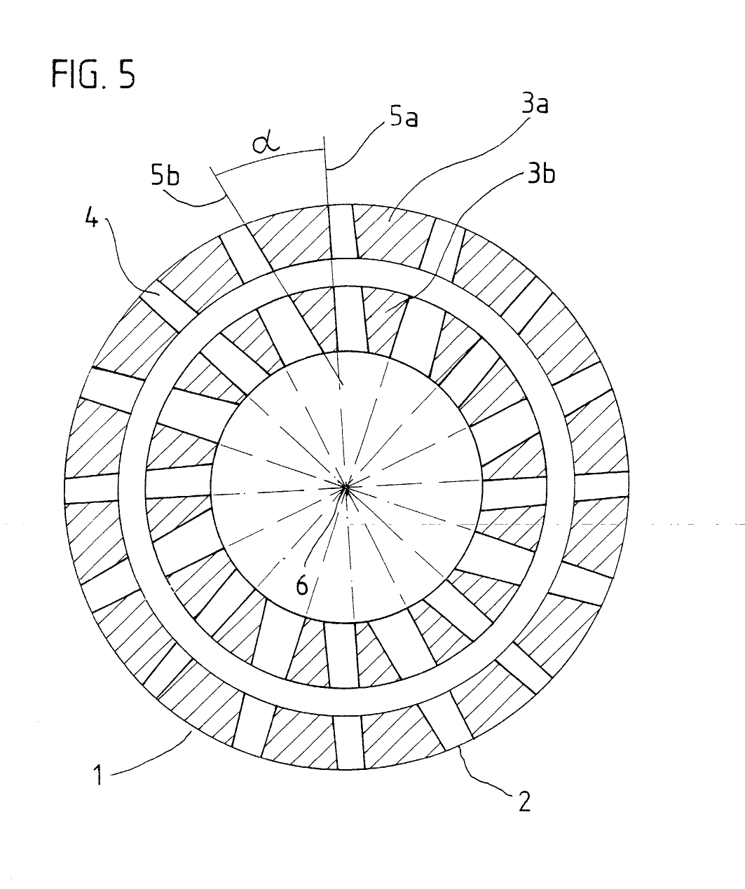

FIG. 5 is a view of the complete sidewall 2 of the vehicle tire 1 shown in FIG. 4. It can be clearly seen that the radial sector transitions and the offset sector transitions are arranged in an alternating manner. The illustration of the vehicle tire in FIG. 5 shows the vehicle tire 1 without a wheel load imposed thereon at the normal tire air pressure. The greater the ratio of the wheel load to the tire air pressure, the more the influence of the rim 10 decreases as opposed to its influence in the unloaded condition of the tire. In this connection, the points along the rim flange and the points along a belt of the vehicle tire 1 relative to the rim 10 do not change. In contrast, the included angle α between the sector transitions 5b changes under the influence of a wheel load. Via a measurement process by the magnetic field sensors 8a, 8b analogous to the measurement process described with respect to FIG. 1, the phase changes can be determined based upon the differences between the angles α, and the tangential deformation can be evaluated in dependence upon, or as a function of, the tire suspension.

The component of the tangential deformation which is independent of the tire suspension can be evaluated from the phase angle portion of the measured signals which are received with respect to those sector transitions 5 having an angle a equal to zero—that is, those sector transitions extending radially through the axis of rotation 6 of the vehicle tire 1.

Upon the imposition of a wheel load—not shown here again (see the condition of the tire shown in FIG. 2 as exemplary for such wheel loading)—the section transitions, which previously, in the unloaded condition of the tire, extended at an angle α equal to zero, now no longer extend radially through the axis of rotation of the vehicle tire 1, but are, instead, angularly displaced. In the 180° position of the magnetic field sensors 8a, 8b, in contrast, the sector transitions 5 extend through the ideal axis of rotation 6 of the vehicle tire 1, so that, in this measurement position, the measurement results are independent of the tire suspension.

Via coupling of the measurement results for both tangential deformations—that is, the tangential deformations respectively independent of, or dependent upon, the tire suspension—a conclusion can be drawn concerning these same tangential deformations.

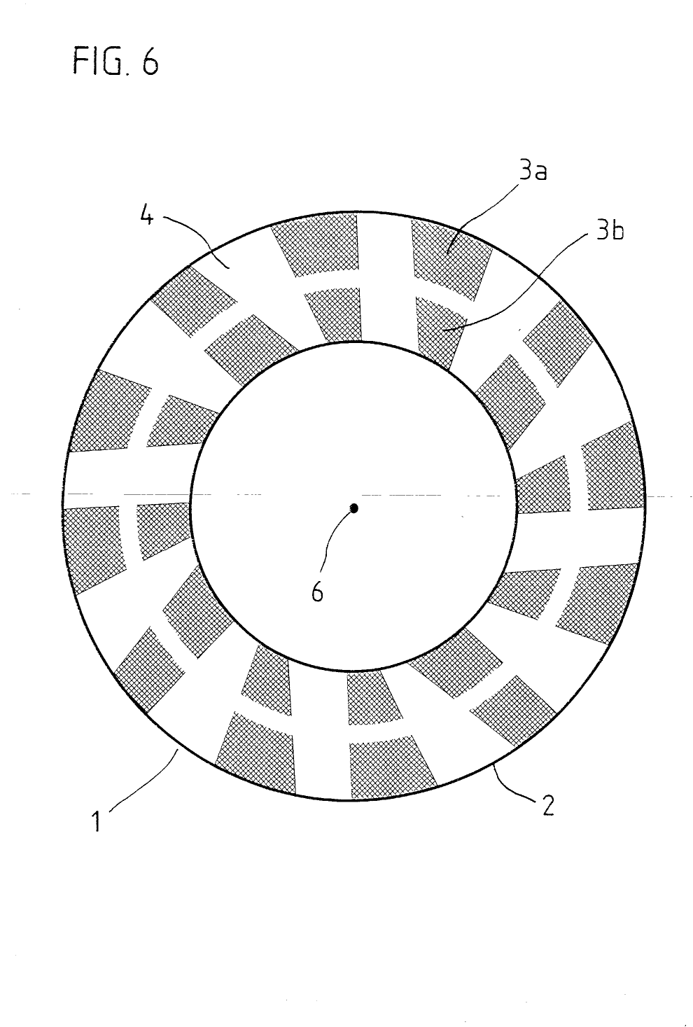

FIG. 6 is a view of a vehicle tire similar to that of FIG. 5 in which can be seen the sidewall 2 of another vehicle tire 1 configured in accordance with the present invention whose transitions between the magnetic sectors 3a, 3b are disposed in three different inclinations (that is, angles relative to the radius), whereby, between the magnetic sectors of the radially outermost and innermost tracks, there is no phase displacement or offset. The cross-hatching, which differs from that shown in FIG. 5, has no technical significance.

In summary, the present invention provides a vehicle tire 1 having at least one regionally magnetizable sidewall 2, whereby, on this sidewall 2, at least one inner track 3a and one outer track 3b of magnetized sectors 4 are provided, whereby each track 3a, 3b, includes a plurality of differently magnetized sectors 4, with the magnetization of the sections preferably being accomplished with alternating magnetic polarity. This makes possible, in addition to the already known characterization of the longitudinal force, a characterization of the tire suspension with the least possible effort.

In this regard, several of the sector transitions 5a between the magnetized sectors 4 extend in a first inclination a relative to a radius of the tire and others of the sector transitions—namely, sector transitions 5b—extend in a second, different inclination β relative to the radius of the vehicle tire 1.

The inclinations differ somewhat proportionally relative to the vehicle suspension at practically all circumferential positions and, especially, in the 0 (zero) degree position while, however, differing as well in the 180° position, which is particularly attractive from a technical measurement point of view; the greater the inclinations of the impacted sector transitions in the unloaded condition of the tire as well, the stronger are these tire suspension proportional inclination differences. The difference between the inclination differences should serve as a measurement of the tire suspension.

In order to generate the largest possible and most easily determinable difference, one of the inclinations should preferably have a value equal to zero. Moreover, a third inclination axis is preferably provided which permits a further performance to be obtained in that the rotational sense of the tire can be recognized, if the sensed result of the inclined sector borders is asymmetrical—that is, if the sensed result generated in connection with the forward rotation of the tire is different than the sensed result generated in connection with the reverse rotation of the tire.

The specification incorporates by reference the disclosure of German priority document 101 33 428.1 filed Jul. 10, 2001.

The present invention is, of course, in no way restricted to the specific disclosure of the specification and drawings, but also encompasses any modifications within the scope of the appended claims.

What is claimed is:

1. A vehicle tire comprising:
a tread;
a pair of sidewalls connected to the tread for supporting the tread on a rim, whereby the rim and the tire secured thereon are rotatable about an axis of rotation, at least one of the sidewalls having at least a radially inner track and a radially outer track, the radially inner track being formed of a plurality of magnetically active sectors arranged in an angular serial manner to one another with each sector being delimited from the next following sector by a respective sector transition and having a different magnetic property than the next following sector and the radially outer track being formed of a plurality of magnetically active sectors arranged in an angular serial manner to one another with each sector being delimited from the next following sector by a respective sector transition and having a different magnetic property than the next following sector, the sectors of the radially inner track being at a first radial spacing from the axis of rotation and the sectors of the radially outer track being at a second radial spacing from the axis of rotation greater than the first radial spacing and, within any given one of the radially inner track and the radially outer track, a first group of the sector transitions have a radial extent forming a first angle relative to a radius of the tire and a second group of the sector transitions have a radial extent forming a second angle relative to a radius of the tire which is different than the first angle formed by the first group of sector transitions of the given one of the tracks.

2. A vehicle tire according to claim 1, wherein the first angle formed by the first group of the sector transitions with a radius of the tire has a value of 0 (zero) degrees.

3. A vehicle tire according to claim 1, wherein, within each of the first track and the second track, the first group of the sector transitions and the second group of the sector transitions are arranged in an alternating manner with one another.

4. A vehicle tire according to claim 1, wherein the magnetically active sectors of at least one of the first track and the second track are further delimited by a third group of sector transitions each of which forms a third angle with a radius of the tire different than the first and second angles.

5. A vehicle tire according to claim 4, wherein, within the respective ones of the first track and the second track having a third group of sector transitions, the first group of the sector transitions, the second group of the sector transitions, and the third group of the sector transitions are arranged in repeating asymmetric periods with one another, with the period preferably being that period having the shortest possible period length.

6. A vehicle tire according to claim 1, wherein, within each of the first track and the second track, the different magnetic property which each magnetically active sector has with respect to the next following magnetically active sector is magnetic field strength including, preferably, for one set of the alternated magnetically active sectors, a magnetic field strength equal to zero.

7. A vehicle tire according to claim 1, wherein, within each of the first track and the second track, the different magnetic property which each magnetically active sector has with respect to the next following magnetically active sector is the direction of magnetic field lines such that one set of the alternated magnetically active sectors has magnetic field lines in one direction and the other set of the alternated magnetically active sectors has magnetic field lines in another direction.

8. A vehicle tire according to claim 1, wherein, within each of the first track and the second track, the different magnetic property which each magnetically active sector has with respect to the next following magnetically active sector is the orientation of magnetic field lines such that one set of the alternated magnetically active sectors has magnetic field lines oriented in one orientation and the other set of the alternated magnetically active sectors has magnetic field lines oriented in another orientation.

9. A vehicle tire according to claim 1, wherein, within each of the first track and the second track, the magnetic field lines in all of the magnetically active sectors of the respective track extend circumferentially and the different magnetic property which each magnetically active sector has with respect to the next following magnetically active sector is the orientation of magnetic field lines such that one set of the alternated magnetically active sectors has magnetic field lines oriented in one direction and the other set of the alternated magnetically active sectors has magnetic field lines oriented in another direction.

10. A system for measuring the deformation of a vehicle tire, the vehicle tire having a tread and a pair of sidewalls connected to the tread for supporting the tread on a rim, whereby the rim and the tire secured thereon are rotatable about an axis of rotation and at least one of the sidewalls having at least a radially inner track and a radially outer track, each track having a plurality of magnetically active sectors arranged in an angular serial manner to one another in the track with each sector being delimited from the next following sector by a respective sector transition and having a different magnetic property than the next following sector and the sectors of the track being at a second radial spacing from the axis of rotation greater than the first radial spacing and each track having a first group of the sector transitions each with a radial extent forming a first angle relative to a radius of the tire and a second group of the sector transitions each with a radial extent forming a second angle relative to a radius of the tire which is greater than the first angle formed by the first group of sector transitions and the vehicle tire undergoing a tangential deformation upon the application of deforming force thereto, the system comprising:
an inner track magnetic field sensor oriented relative to the radially inner track for magnetically sensing its plurality of magnetically active sectors;
an outer track magnetic field sensor oriented relative to the radially outer track for magnetically sensing its plurality of magnetically active sectors; and
an evaluation unit operably coupled to the inner track magnetic field sensor and the outer track magnetic field sensor for evaluating the phase angles between the signals generated by the inner track magnetic field sensor and the outer track magnetic field sensor as they sense the magnetically active sectors of the tracks passing therepast, the evaluation unit being operable to render an evaluation of the phase angles between the signals generated with respect to the first group of sector transitions as one indication of the tangential deformation of the vehicle tire and to render an evaluation of the phase angles between the signals generated with respect to the second group of sector transitions as another indication of the tangential deformation of the vehicle tire which varies relatively more strongly as a function of the damping characteristic of the vehicle tire than the one indication varies as a function of the damping characteristic of the vehicle tire.

11. A system according to claim 10, wherein the inner track magnetic field sensor and the outer track magnetic field sensor are disposed on a diametric line perpendicular to the road contact surface on which the vehicle tire rolls above the axis of rotation of the vehicle tire.

12. A system according to claim 10, wherein the evaluation unit is operable to render an evaluation of the relationship to one another of the one indication of the tangential deformation of the vehicle tire and the another indication of the tangential deformation of the vehicle tire.

13. A system according to claim 10, wherein the magnetically active sectors of at least one of the radially inner track and the radially outer track of the vehicle tire are further delimited by a third group of sector transitions each of which forms a third angle with a radius of the tire different than the first and second angles and, within the respective ones of the first track and the second track having a third group of sector transitions, the first group of the sector transitions, the second group of the sector transitions, and the third group of the sector transitions are arranged in repeating asymmetric periods with one another, with the period preferably being that period having the shortest possible period length and the evaluation unit is operable to render an evaluation of the direction of rotation of the vehicle tire as a function of signals generated by the inner track magnetic field sensor and the outer track magnetic field sensor in connection with sensing of the third group of sector transitions.

14. A method for measuring the deformation of a vehicle tire, the vehicle tire having a tread and a pair of sidewalls connected to the tread for supporting the tread on a rim, whereby the rim and the tire secured thereon are rotatable about an axis of rotation and at least one of the sidewalls having at least a radially inner track and a radially outer track, each track having a plurality of magnetically active sectors arranged in an angular serial manner to one another in the track with each sector being delimited from the next following sector by a respective sector transition and having a different magnetic property than the next following sector and the sectors of the track being at a second radial spacing from the axis of rotation greater than the first radial spacing and each track having a first group of the sector transitions each with a radial extent forming a first angle relative to a radius of the tire and a second group of the sector transitions each with a radial extent forming a second angle relative to a radius of the tire which is greater than the first angle formed by the first group of sector transitions and the vehicle tire undergoing a tangential deformation upon the application of deforming force thereto, the method comprising:
magnetically sensing the plurality of magnetically active sectors of the radially inner track and the plurality of magnetically active sectors of the radially outer track;
evaluating the phase angles between the signals generated with respect to the first group of sector transitions as one indication of the tangential deformation of the vehicle tire; and
evaluating the phase angles between the signals generated with respect to the second group of sector transitions as another indication of the tangential deformation of the vehicle tire which varies relatively more strongly as a function of the damping characteristic of the vehicle tire than the one indication varies as a function of the damping characteristic of the vehicle tire.

15. A method according to claim 14 and further comprising evaluating the relationship of the phase angles between the signals generated with respect to the first group of sector transitions and the phase angles between the signals generated with respect to the second group of sector transitions.
